(19) United States
(12) Patent Application Publication
(10) Pub. No.: US 2009/0199582 A1
(43) Pub. Date: Aug. 13, 2009

(54) Air Conditioning System Operating On A Supercritical Cycle For Use In Motor Vehicles

(75) Inventor: Thomas Justin, Brignais (FR)

Correspondence Address: WRB-IP LLP, 1217 KING STREET, ALEXANDRIA, VA, 22314, US

(73) Assignee: RENAULT TRUCKS, Saint Priest (FR)

(21) Appl. No.: 12/305,022

(22) PCT Filed: Jul. 4, 2006
(86) PCT No.: PCT/FR2006/050676

§ 371 Date: Dec. 16, 2008

(51) Int. Cl. B60H 1/32; F25B 1/00; B60H 3/02

(52) U.S. Cl. 62/239; 62/498; 62/274

(57) ABSTRACT

An air conditioning system operates on a supercritical cycle for a vehicle and includes a circuit through which a refrigerant flows, which circuit includes an evaporator where the refrigerant collects heat from the ventilation air to be conditioned, a compressor, a cooler where the refrigerant releases heat into the outside air, an expander, and an arrangement for humidifying the outside air that contacts the cooler. The system has no internal heat exchanger.

### TECHNICAL FIELD

The invention relates to the field of air conditioning systems used in motor vehicles. It relates more particularly to particular arrangements of the air conditioning system which optimize performance while simplifying the refrigerant circuit, in particular when the latter is operating with a supercritical cycle.

### PRIOR ART

Generally, and as illustrated in FIG. 1, an air conditioning unit 1 has four main components, namely an evaporator 2, a compressor 3, a gas cooler heat exchanger or condenser 4, and an expander 5, these being connected by a circuit through which a refrigerant flows.

The thermodynamic cycle of an air conditioning unit operating on a basic supercritical cycle, as illustrated by the bold line in FIG. 2, has a first phase corresponding to the transition between points A1 and A2. During this first phase, the evaporator 2 collects the heat from the ventilation air circuit to be cooled 7 while remaining at a constant pressure of the order of a few bar. The refrigerant which has thus collected this heat is then compressed in a compressor 3 during the phase corresponding to the transition between points A2 and A3. The compressed fluid then passes into the cooler or condenser 4. This cooler is a heat exchanger at which the refrigerant releases some of its heat to the outside environment 8 in the phase corresponding substantially to the transition between points A3 and A4. The fluid remains at increased pressure, greater than around ten bar. Next, the pressure of the refrigerant drops as it passes through the expander 5, corresponding to the transition phase between points A4 and A1. The fluid then passes back into the evaporator 2.

The criteria governing the choice of refrigerant include in particular questions of regulations concerning respect for the environment. These criteria have led in particular to envisioning the replacement of refrigerants of the chlorofluorocarbon type with fluids such as carbon dioxide, for example, which also enables air conditioning systems to operate on a supercritical cycle.

In air conditioning systems operating on a supercritical cycle, the temperature and the pressure may be above the critical point, meaning that the passage from the gaseous state to the liquid state cannot be physically defined. The consequences include the fact that the element via which the heat collected is transferred to the outside environment is not where condensation occurs but merely where the refrigerant is cooled. There is therefore no condensation in the gas cooler heat exchanger. Thus using the term “condenser” to define a conventional air conditioning system is not precise from a physical point of view in a system operating on a supercritical cycle. Hence, in the rest of the description, this element will be known as a “cooler”. Although using systems operating on a supercritical cycle is appropriate for environmental reasons, there are a number of constraints in terms of sizing. This is because the pressures prevailing in the refrigerant circuit are frequently above 100 bar for temperatures of around 150° C., or more. The various components of the refrigerant circuit, and in particular the lines and connectors, must therefore be designed and sized accordingly.

Generally, the efficiency of an air conditioning unit is evaluated by measuring a performance coefficient. This performance coefficient is equal to the ratio of the power taken off from the stream of ventilation air to be cooled to the power consumed by the compressor.

Thus, in order to obtain a satisfactory performance coefficient when using a system operating on a supercritical cycle, it is necessary to use a complementary device known as an “internal heat exchanger” as is described, for example, in document EP-1 316 450. This internal heat exchanger 9, as is illustrated in FIG. 1, enables the high pressure refrigerant to be cooled at the outlet from the cooler 8 by transferring part of its heat to the low pressure refrigerant emerging from the evaporator 2. The corresponding thermodynamic cycle is illustrated by the dotted line in FIG. 2. The passage of the low pressure refrigerant emerging from the evaporator into the internal heat exchanger corresponds to the transition from point A2 to point A2′. During this phase, a quantity of heat is received from the high pressure fluid at the outlet from the cooler 8. Compression takes place between points A2′ and A3′ and is followed by cooling within the cooler 8 between points A3′ and A4. A complementary drop in temperature is obtained on passing through the internal heat exchanger 9, corresponding to the transition between points A4 and A4′. Passing through the expander 5 causes a lowering of pressure, between points A4′ and A1′. Next, the fluid heats up inside the evaporator 2, between points A1′ and A2. Overall, the performance coefficient is improved by virtue of this internal heat exchanger 9, since it is equal to the ratio of the enthalpy differences between phases A1′-A2 and A2′-A3′.

It can be seen, however, that the use of this internal heat exchanger, even though it is necessary in order to obtain a satisfactory performance coefficient, makes the refrigerant circuit more complicated. What is even more disadvantageous is that it brings about increased temperature and pressure levels. This is because, by virtue of the drop in temperature of the fluid upstream of the expander 5, heat exchanges in the evaporator 2 are more efficient since the refrigerant is at a lower temperature. Nevertheless, this improvement in heat exchange in the evaporator translates into an increase, at the internal heat exchanger 9, in the temperature of the fluid to be compressed. Thus, the compressed fluid in the cooler 4 is at a very high temperature and a high pressure. This consequently entails constraints in terms of leaktightness and the integrity of the materials. The use of complementary components also leads to an increase in the weight and the overall cost price of the circuit.

### SUMMARY OF THE INVENTION

One of the objects of the invention is to enable the air conditioning circuit to operate with a performance coefficient which is higher than those measured in existing systems. Another object of the invention is to simplify the refrigerant circuit by reducing the weight, the volume and thus as a result the cost of the air conditioning circuit. Another object is to decrease the number of areas exposed to the risk of leaks and necessitating complicated sizing. Another object of the invention is to enable operation at lower refrigerant pressures so as to reduce internal pressure drops and to enable the use of less expensive materials in order to produce the various elements of the circuit.

Thus the air conditioning system according to the invention is characterized in that it has means for humidifying the outside air used for cooling the cooler and in that it has no internal heat exchanger.

In other words, the invention consists in improving the cooling of the refrigerant at the cooler by the evaporation of a certain amount of water that is introduced into the outside air coming into contact with the cooler, which collects the heat dissipated by the cooler. In a particular embodiment, this water can be sprayed in the form of microdroplets at the cooler. In. this way, the heat collected by these microdroplets enables some of it to be vaporized, within the vapor saturation limit of the air in contact with the cooler. Thus the refrigerant temperature at the outlet from the cooler is lowered, with the result that it is possible to omit the internal heat exchanger used in previous systems in order to deliver to the expander a refrigerant at a sufficiently low temperature. The temperature is lowered in this way without the drawback observed in the prior art of an increase in the temperature and the pressure of the fluid before it enters the cooler.

In other words, the use of evaporation at the cooler enables the performance of the latter, and as a result the performance coefficient of the system as a whole, to be improved. The improvement in the performance coefficient is even better in combination with a reduction in the complexity of the refrigerant circuit, and more precisely by removing the internal heat exchanger which was necessary in prior art systems. This advantage is further emphasized by the fact that the maximum pressure and/or temperature is/are reduced. This is because the compression phase starts at the dew point and not at a higher temperature such as after passing through the internal heat exchanger of the prior art, this being favorable for the sizing of the air conditioning installation.

The water may be sprayed directly onto the cooler, or else into an air stream for ventilating the cooler. Ventilation may be forced or may be the result of natural convection, depending on the desired performance and the powers employed. It is also possible to use humidified porous materials generally known as “wetted media”, through which the ventilation air may pass so as to acquire humidity which is then vaporized upon contact with the cooler.

According to another feature of the invention, the means for humidifying the air in contact with the cooler can be supplied by recovering the water that is condensed at the evaporator. In this way, all or some of the water produced at the evaporator can be put to good use and reused for cooling the cooler in accordance with the invention. When enough water is produced at the evaporator with respect to consumption in order to cool the cooler, autonomy can be obtained. It is also possible for this spraying to be carried out using an independent and autonomous reserve.

### BRIEF DESCRIPTION OF THE FIGURES

The way of implementing the invention and the advantages arising therefrom will become apparent from the following description of an embodiment with reference to the attached drawings, in which:

FIG. 1 shows a simplified diagram of an air conditioning system operating with a supercritical refrigerant according to the prior art;

FIG. 2 shows an enthalpy/pressure diagram showing the steps of the thermodynamic cycle of prior art systems in simplified form;

FIG. 3 shows a simplified diagram of the air conditioning system according to the invention; and

FIG. 4 shows an enthalpy/pressure diagram showing the various steps of the thermodynamic cycle of the refrigerant in simplified form.

### WAY OF IMPLEMENTING THE INVENTION

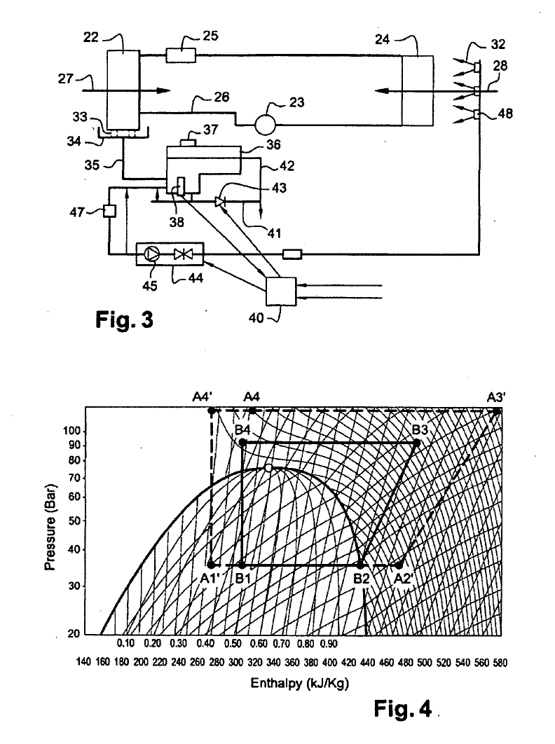

The air conditioning system illustrated in FIG. 3 has, in a conventional manner, an evaporator 22 through which an air stream 27 to be cooled flows. This evaporator 22 has an internal circuit connected to the refrigerant circuit 26. The outlet from the evaporator 22 is connected to a compressor 23 which compresses this refrigerant. The cooling step takes place under temperature and pressure conditions above the critical point of the fluid and this justifies the qualifier “supercritical”. By way of example, the fluid used on a supercritical cycle can be carbon dioxide, the pressure and temperature of the critical point of which are respectively 73 bar and 32° C. Following cooling in the cooler 24, the refrigerant is expanded at the expander 25 in order subsequently to pass into the evaporator 22 at reduced pressure.

In accordance with the invention, the cooler 24 is linked to means for humidifying the outside air coming into contact with the cooler. In the embodiment illustrated, liquid water 32 is sprayed into the outside air in order to collect some of the heat dissipated by the cooler 24 in order. to increase the heat exchange within the cooler 24. This spraying may Lake place directly on the cooler 24 itself or preferably into the air stream 28 which will be brought by ventilation into contact with the cooler 24. This cooling by evaporation gives the air conditioning system a satisfactory performance coefficient without requiring the addition of an internal heat exchanger as is used in existing systems.

According to one feature of the invention, the water 32 which is used at the cooler 24 can advantageously be recovered at the evaporator 22 where some of the water contained in the stream 27 of ventilation air to be cooled condenses.

As illustrated in FIG. 3, this water 33 can be collected by flowing into a collector 34 and then being conveyed through a suitable line 35 to a tank 36. The tank allows any discrepancies between the flow rate of condensate and the flow rate required for humidification to be dealt with. This tank 36 may optionally be supplied with water from the outside via the opening 37 in order to commence operation of the device when insufficient water has been produced at the evaporator 22 or when the weather conditions do not allow it. This tank 36 may be provided with a sensor 38 for sensing the volume of water it contains, the information provided by this sensor being fed to a suitable monitoring and control unit 40 managing the system. A mechanism for emptying 41 and for evacuating an overflow 42 may also be provided. The emptying 41 may also take place by opening a valve 43 controlled by the abovementioned monitoring control unit.

In order for the invention to operate, a quantity of water may be taken from the bottom of the tank 36 in order to be conveyed to near the cooler 24. For this purpose, a metering mechanism 41 including in particular a pump 45, for example a volumetric pump, controlled by the monitoring control unit 40 ensures the characteristic spraying of a given quantity at moments selected to optimize the operation of the air conditioning system. Filtering devices 47 may be provided upstream of the metering system in order to prevent any clogging of the pump 45 and downstream of the metering system 44 in order to prevent clogging of the spraying elements. When humidification is produced by spraying, the elements carrying out this spraying may consist in particular of high-pressure nozzles 48, with the diameter of the nozzles and the water pressure determining the size of the droplets.

The thermodynamic cycle of the system according to the invention is illustrated in a simplified manner as the solid line in FIG. 4, in comparison with a prior art system including an internal heat exchanger shown as the dotted line.

Thus, the heat collected by the refrigerant at the evaporator 22 corresponds to the transition between points B1 and B2 in the diagram, during which, at constant pressure, the enthalpy of the refrigerant increases. The variation in enthalpy during this phase corresponds to the energy collected by the system from the stream 27 of ventilation air to be cooled. The transition between points B2 and B3 corresponds to the compression phase, in which the pressure. of the refrigerant increases, typically from 30-40 bar to about 90 bar. The variation in enthalpy during this phase corresponds to the energy consumed by the compressor, within the efficiency range of the latter.

The performance coefficient of the system is thus calculated by the ratio of the energy collected from the air stream, i.e. the difference in enthalpy between points B1 and B2, to the energy consumed by the compressor, i.e. the difference in enthalpy between points B2 and B3.

It can thus be seen in the particular example, corresponding to extreme ambient temperature conditions, for example 40° C. outside temperature with a humidity of around 50%, that the performance coefficient is around 1.90.

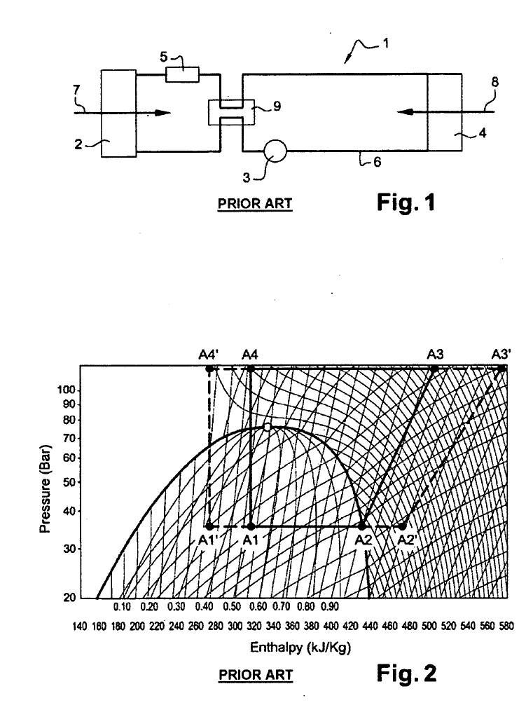

By comparison, a similar cycle implemented on a prior art system including an internal heat exchanger has a performance coefficient of around 1.5. This coefficient is calculated taking into account the energy collected at the evaporator 22, corresponding to the transition between points A1′ and B2, in relation to the compression phase illustrated between points A2′ and A3′ . The increase in temperature between the outlet from the evaporator 22 and the inlet to the compressor 23, illustrated by the transition between points B2 and A2′, corresponds to the heating occurring by way of the internal heat exchanger as illustrated in FIG. 1.

By way of example of a numerical comparison, the temperature of the stream at the outlet from the compressor 27 in the system according to the invention is around 92° C. (B3), compared with a temperature close to 160° C. (A3′) at the outlet from the compressor 3 in the prior art. Similarly, in the prior art a complementary lowering of the temperature takes place at the internal heat exchanger 9, with the temperature of around 45° C. at the outlet from the cooler 4 dropping to a temperature of around 35° C. at the inlet to the expander 5, this corresponding to the transition illustrated between points A4 and A4′.

Conversely, in the device according to the invention, the same temperature of around 35° C. is obtained directly at the outlet from the cooler 24. In other words, the system according to the invention is advantageous in that it allows operation at a lower temperature with a more favorable performance coefficient, combined with a simpler refrigerant circuit structure.

A comparison of the pressure levels reached also favors the invention, since at a better performance coefficient (1.90 compared with 1.50), the maximum pressure reached in the circuit is around 90 bar compared with the 120 bar observed in the prior art in the presence of an internal heat exchanger. Such an improvement can be obtained since a sufficient quantity of water is available, in particular if the production of water recovered at the evaporator makes it possible to achieve autonomy. This depends, of course, on the climatic conditions and particularly on the ambient humidity and the ambient temperature. Thus, the maximum temperatures and pressures reached in the cooler can be optimized as a function of these climatic conditions.

Thus, for the same performance, it is possible to use smaller compressors or compressors which consume less. It is also possible to define cycles where the maximum pressure is less, and this is advantageous in terms of the design of the refrigerant circuit.

1. An air conditioning system operating on a supercritical cycle for a vehicle, comprising a circuit through which a refrigerant flows, the circuit having an evaporator at which the refrigerant collects heat from the ventilation air to be conditioned, a compressor, a cooler at which the refrigerant releases heat into the outside air, and an expander, wherein it has means for humidifying the outside air coming into contact with the cooler and in that it has no internal heat exchanger.

2. The system as claimed in claim 1, wherein the means for humidifying the outside air are supplied by recovering the water that is condensed at the evaporator.

3. The system as claimed in claim 1, wherein the means for humidifying the outside air spray water into the outside air.

4. The system as claimed in claim 1, wherein the means for humidifying the outside air pass the outside air through a humidified medium.

5. The system as claimed in claim 1, wherein the means for humidifying the outside air spray water onto the cooler.

6. The air conditioning system as claimed in claim 1, wherein it has means for ventilating the cooler with humidified outside air.

7. The air conditioning system as claimed in claim 2, wherein it has a tank supplied with water that is condensed at the evaporator.

8. The air conditioning system as claimed in claim 1, wherein the refrigerant is carbon dioxide.

9. The air conditioning system as claimed in claim 1, wherein it has a system for metering the water humidifying the outside air.
